(19) United States
(12) Patent Application Publication
(10) Pub. No.: US 2010/0332294 A1
(43) Pub. Date: Dec. 30, 2010

(54) METHOD AND SYSTEMS FOR MONITORING MACHINE AND OPERATOR PRODUCTIVITY AND PROFITABILITY

(75) Inventors: CHAD W. GEIS, Ruston, LA (US); DALLAS L. GEIS, Ruston, LA (US)

Correspondence Address: MCKEE, VOORHEES & SEASE, P.L.C., 801 GRAND AVENUE, SUITE 3200, DES MOINES, IA, 50309-2721, US

(73) Assignee: GENESIS INDUSTRIES LLC, Arcadia, LA (US)

(21) Appl. No.: 12/824,658

(22) Filed: Jun. 28, 2010

Related U.S. Application Data
(60) Provisional application No. 61/221,428, filed on Jun. 29, 2009.
(60) Provisional application No. 61/296,282, filed on Jan. 19, 2010.

(51) Int. Cl. G06Q 10/00

(52) U.S. Cl. 705/11; 705/7

(57) ABSTRACT

A method includes collecting cost data indicative of production systems using machinery on or in conjunction with natural resource management using an onboard computer of the machine, collecting environmental data using the onboard computer, the environmental data indicative of environmental conditions associated with use of the machine and/or management and production of a natural resource, collecting machine and/or natural resource data using the onboard computer, the machine data indicative of operation of the machine and production of the natural resource, and performing an analysis of at least one of cost data or revenue data using the environmental data and the machine data, the analysis performed using the onboard computer or a computer remotely connected.

### CROSS-REFERENCE TO RELATED APPLICATIONS

This application claims priority under 35 U.S.C. §119(e) to provisional application Ser. No. 61/221,428 filed Jun. 29, 2009 and U.S. Ser. No. 61/296,282 filed Jan. 19, 2010, each of which is herein incorporated by reference in its entirety.

### FIELD OF THE INVENTION

The present invention relates to monitoring the productivity and/or profitability associated with machines, machine operators, and groups of machine or machine operators. More specially, but not exclusively, the present invention relates to monitoring machines and machine operators as operations are being performed so as to provide feedback regarding productivity and profitability.

### BACKGROUND OF THE INVENTION

In industries such as, without limitation, agriculture, forestry, and construction, natural resources are managed in various ways. Often times, machine operations are performed on land or other natural resources by operator controlled machinery or equipment. There are numerous variables associated with performing these activities. These variables may impact productivity of machines or their operators as well as revenue or profitability of a business. Unfortunately, the impact of these variables on productivity as well as revenue and profitability remains generally unknown, and unmeasured.

What is needed are methods and systems which allow for monitoring and/or outputting information indicative of productivity and/or profitability.

### BRIEF SUMMARY OF THE INVENTION

A method for profitability monitoring of equipment operations being performed on a natural resource includes a computer system linked directly or indirectly with said piece of equipment, singularly or collectively, into which costs, both fixed and variable, along with revenue rates—derived from the operation and/or the natural resource, actual or theoretical, can be entered. The associated costs, as well as, revenue rates are input and integrated into a Geographical Information System (GIS) which is being run directly on or in association with the aforementioned equipment, singularly or collectively. The system also includes collecting operator data indicative of an operator's use of a machine using an onboard computer of the machine, collecting data concerning the application of production inputs during operations, collecting environmental data using the onboard computer, the environmental data indicative of environmental conditions associated with use of the machine, collecting machine data using the onboard computer, the machine data indicative of operation of the machine. The onboard computer is connected to a Global Positioning System (GPS) in such a fashion as to allow for the recording of 4D geospatial data (latitude, longitude, elevation, and time) pertinent to the location in which said machine operations are being performed and recording said information into a GIS at the time the operation is performed. The method further includes performing an analysis of the operational data, the environmental data, and the machine data stored in the GIS to assist in profitability modeling as well as modeling of the environment in/on which the machine is operating. The analysis may be performed using the onboard computer or remotely.

A system for monitoring profitability associated with a machine may include, but not be limited to, an onboard computer on the machine containing a GIS, a GPS, a wireless data transfer device, a display electrically connected to the onboard computer, at least one environmental monitoring sensor electrically connected to the onboard computer, and at least one machine operation monitoring sensor electrically connected to the onboard computer.

According to one aspect, a method includes collecting operational and input cost data indicative of production systems using machinery on a natural resource using an onboard computer of the machine, and collecting environmental data using the onboard computer, the environmental data indicative of environmental conditions associated with use of the machine. The method further includes collecting machine data using the onboard computer, the machine data indicative of operation of the machine. The method further includes performing an analysis of at least one of cost data or revenue data using the environmental data and the machine production data, the analysis performed using the onboard computer or a remote computer.

According to another aspect of the present invention, a system for monitoring productivity associated with a machine is provided. The system includes an onboard system on the machine, a display electrically connected to the onboard system, at least one environmental monitoring sensor electrically connected to the onboard system, and at least one machine operation monitoring sensor electrically connected to the onboard sensor. The onboard system is programmed to perform financial analysis functions using data acquired from the at least one environmental monitoring sensor and the at least one machine operation monitoring sensor. The system also allows for the transmission of collected data to computer systems for remote analysis either wirelessly or manually.

According to another aspect of the present invention, a method is provided. The method includes collecting operator data indicative of operator use of a machine using an onboard computer of the machine, collecting environmental data using the onboard computer, the environmental data indicative of environmental conditions associated with use of the machine, collecting machine data using the onboard computer, the machine data indicative of operation of the machine, and performing an analysis of the operator data, the environmental data, and the machine data using the data collected by the onboard computer.

According to another aspect of the present invention, a system for monitoring productivity associated with a machine is provided. The system includes an onboard system on the machine, a display electrically connected to the onboard system, at least one operator monitoring sensor electrically connected to the onboard system, at least one environmental monitoring sensor electrically connected to the onboard system, and at least one machine operation monitoring sensor electrically connected to the onboard system.

### BRIEF DESCRIPTION OF THE FIGURES

FIG. 1 is a flow chart showing information flow.

FIG. 2 is a block diagram illustrating one embodiment of a system for the present invention.

FIG. 3A is an example of a screen display showing a report of bulldozer efficiency as affected by soil texture and soil moisture.

FIG. 3B is an example of a screen display showing bulldozer operating costs.

FIG. 4A is an example of a screen display of timber harvesting efficiency as affected by percent slope.

FIG. 4B is an example of a screen display of timber harvesting revenue over time.

FIG. 5 is a LIDAR image of productivity changes over a specified geographic area.

FIG. 6 is an example of a screen display illustrating real-time profitability for a bulldozer.

FIG. 7 is an example of a screen display illustrating real-time profitability monitoring for agricultural operations.

FIG. 8 is an example of a screen display illustrating real-time profitability for agricultural harvesting.

### DETAILED DESCRIPTION OF THE PREFERRED EMBODIMENT

Efficient, effective, and profitable use and management of machines associated with natural resource management or management of the natural resource itself is desirable, yet problematic. There exist numerous variables that affect the true productivity or profitability of individual or collective pieces of equipment in their designed operations, with said variables being greatly influenced by the environment in which the equipment is operating in/on. For example, environmental factors may influence production and input costs and consequently profitability. Examples of such environmental factors include, but are not limited to, geologic, hydrologic, and atmospheric factors. These environmental factors also influence the overall productivity and profitability of the machine, its operator, and the natural resource which is being managed.

Historically, monitoring and recording the influence of various environmental and production elements on operational costs/revenue, and modeling them into a true profit/loss or break-even analysis has been difficult if not impossible. Historically, profit/loss analyses have been performed by means of accounting for operational and input costs, both fixed and variable, and allocating them against whatever revenue is generated or anticipated by an operation and/or the natural resource without fully accounting for the influence of the work environment in which operations are being performed.

Current systems of monitoring equipment may incorporate a Global Positioning System, hereafter referred to as GPS, to monitor the location of a machine in terms of travel in a linear fashion or plane with no direct correlation to dynamic external conditions and their corresponding impact on the operator and/or machine productivity and profitability. However, current equipment monitoring systems do not allow for the incorporation of operational costs, both fixed and variable, along with revenue rates, and associate them with the real-time operation of a piece of equipment on a natural resource.

Currently, a means does not exist by which to collect and/or evaluate the influence of dynamic operational cost/revenue variables individually or collectively as they occur and/or how they are influenced by the conditions of the operating environment. Therefore, the problem for entities that own, operate, contract, subcontract, or bid work involving powered machinery and/or equipment, as well as manage natural resources for the purposes to include but not be limited to profitable production and utilization of commodities is determining the correlation between profitability and production as influenced by these dynamic variables at a specific location at any specified period of time whether past, present, or future.

Furthermore, challenges exist for equipment manufacturers to design, engineer and create equipment capable of consistently maximizing profitable mechanical operational potential. Given the infinitely changing combination of these geospatial variables associated with maximum potential operational profitability, the goal is to quantify the influence of the aforementioned variables as to incorporate them into theoretical models to predict operational profitability of machine operation, and where applicable, the natural resource itself, when operating under a given set of parameters or utilize the collected geospatial data along with operational and input costs for utilization in subsequent profitability analyses and predictions. In addition to designing features or functions of a machine to adapt to or deal with the dynamic costs and conditions associated with production; equipment manufactures or other entities have not produced a device or system that can monitor, record, and model the impact of multiple production variables and their associated costs as they continually interact with each other.

The impacts of a limited ability to collect and analyze the multiple factors that affect a machine or a natural resources' operational costs in a real-time or post process fashion include, but are not limited to, the need to manually gather all costs, fixed and variable, for analysis along with suboptimal: equipment and operator performance, equipment selection for operations being performed, and/or equipment design and/or the yield/production of a natural resource.

Examples of the negative economic impacts resulting from inadequately accounting for the influence of environment on production and input costs may include the following:

Through an improper accounting of the factors influencing the potential and actual output and the associated cost of operations pertaining to equipment operations whether singularly or collectively, and/or a natural resource, poor business decisions can be made when dealing with job costing and pricing for any specified job which involves the interaction between people, machines, the environment, and/or natural resources. Profit potential may be over or underestimated based on assumed factors such as a machine or natural resources' average potential or actual production capabilities when dealing with the variable environmental and human elements of production. Furthermore, the inability to optimize the efficiency of any or all machinery and/or natural resource inputs, leads to artificially or unnecessarily high costs for goods and services that are dependent on the use of equipment and/or land for their acquisition, processing, or production or an underestimation of operational and input costs and the impact of the work environment on said costs.

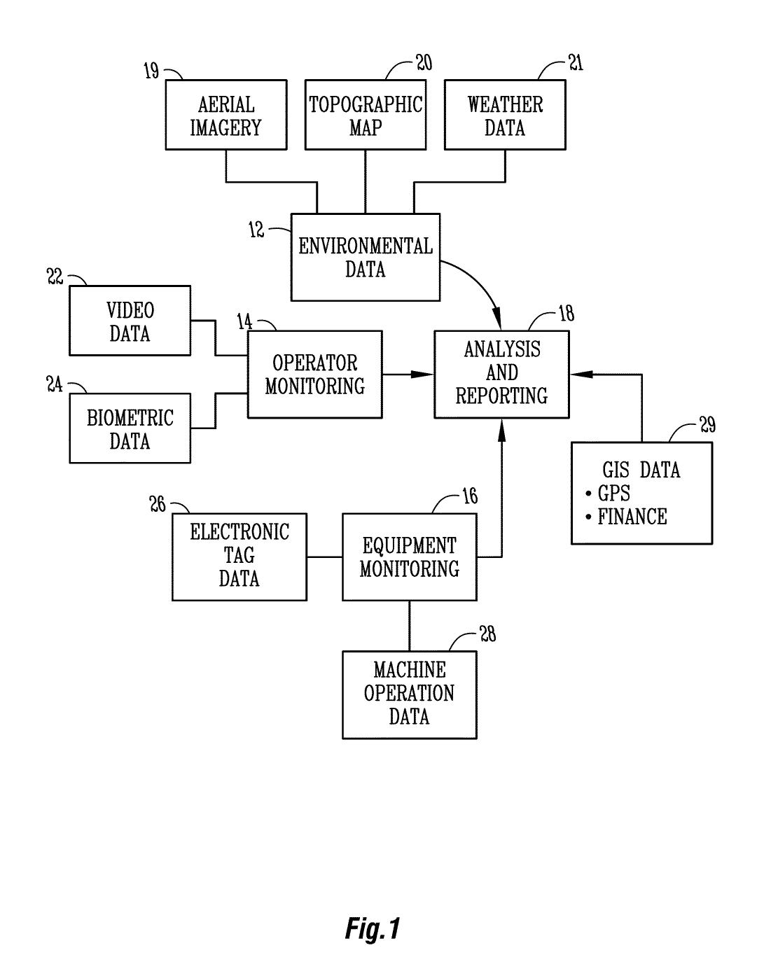

FIG. 1 is a flow chart showing information flow. In FIG. 1, environmental monitoring 12 is performed. Operator monitoring 14 and equipment monitoring 16 are also performed. These steps generate data which is used for analysis and reporting 18. The environmental monitoring 12 may include, but is not limited to, collecting aerial imagery data 19, topographical data 20, and atmospheric data 21. The operation monitoring 14 may include collecting video data 22 and operator biometric data 24. The equipment monitoring 16 may include collecting machine operation data 28, and electronically tagged resource data 26. The electronically tagged resource data 26 may include data regarding the presence or proximity of electronic tags associations with individuals or other machines or equipment. The analysis and reporting may provide for productivity reporting for the machine or operator as well as operating cost reporting, expense reporting, and/or expected revenue reporting. GIS data 29, which may include GPS or other location data and financial data may be input into the analysis and reporting 16.

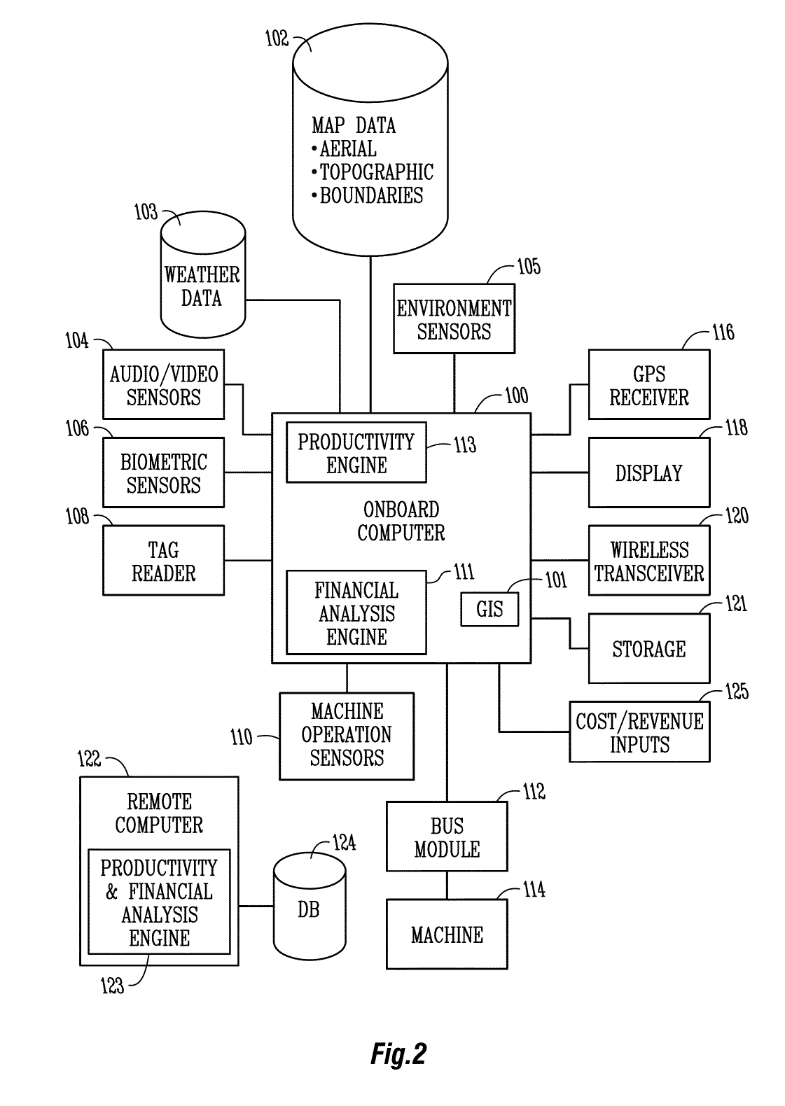

FIG. 2 is a block diagram illustrating one embodiment of a system for the present invention. In FIG. 2, an onboard computer 100 is shown. The onboard computer is associated with an article of machinery or piece of equipment or other machine. A geographic information system (GIS) application 101 may be stored in a computer readable storage medium and executed on the onboard computer 100. The onboard computer 100 allows for the input of operating and input costs, fixed and/or variable, revenue rates, actual or theoretical, as well as, the collection or use of various types of data collected from various sources, including a GPS 116. The data collected may relate to an operator, an environment, a machine, or a natural resource. In addition, a financial analysis application or engine 111 may be stored in a computer readable storage medium and executed on the onboard computer 100 or on a remote computer 122. The financial analysis engine 111 may be a separate software application from the GIS application 101. Alternatively, the financial analysis engine 111 may include accounting functions which are performed by or integrated into the GIS application 101. Examples of financial functions may include, without limitation, machine costs for performing a machine operation, machine costs over time/area or per unit time/area, fuel costs for performing particular machine operations, fuel costs over time/area or per unit time/area, revenue associated with a particular machine operation, revenue over time/area or per unit time/area for performing a machine operation, comparisons of actual costs with optimal costs, comparisons of actual costs associated with budgeted costs, and any number of other functions. Additional financial analyses may pertain to, but not be limited to, costs/revenues incurred/generated by the natural resource itself. In addition, a productivity application or engine 113 may be stored in a computer readable storage medium and executed on the onboard computer 100. The productivity engine 113 may be a separate software application from the GIS application 101. Alternatively, the productivity engine 113 may include productivity functions which are performed by or integrated into the GIS application 101. Examples of productivity functions may include, without limitation, number of particular machine operations performed within a period of time, comparisons because the number of particular machine operations performed within a period of time and optimal or expected or estimated numbers of machine operations to perform with a particular amount of time, and any number of other functions. Production data may pertain, but not be limited to, yield/output of the natural resource itself. Productivity functions may relate to the number of machine operations, the work path of a machine, the size, weight, or volume of a load associated with a machine operation, or other parameters including those related to the machine operation sensors 110, the environment sensors 105, the weather data 103, the audio/video sensors 104, the biometric sensors 106, or the tag reader 108.

As shown in FIG. 2, map data may be stored in a GIS database 102. Similarly, weather data may be stored in the GIS database 103. Each of these sources of data is accessible by the onboard computer 100. In addition, environmental sensors 105 may be electrically connected to the onboard computer 100 to collect additional environmental data.

Also, environmental sensors 105 may be electrically connected to the onboard computer 100. The environmental sensors 105 may be used to measure geological, hydrological, and/or atmospheric parameters influencing the performance, and hence the operational and input costs of a piece of equipment operating on a natural resource as well as the natural resource itself.

In addition, machine operation sensors 110 may be electrically connected to the onboard computer 100. The machine operation sensors may be associated with the state of the machine. A bus module 112 may electrically connect the onboard computer 100 to a machine 114. The connection of the bus module 112 allows for monitoring of activity associated with machine operations 114 which ultimately impact the profit/loss model of operating a particular piece of equipment within a given work environment or a natural resource itself.

A financial analysis engine 111 may be stored on a computer readable storage medium accessible by the onboard computer 100. The financial analysis engine 111 may use cost/revenue inputs 125 input by a user or acquired from another computer, software system, or otherwise.

Other systems which may be electrically connected to the onboard computer 100 include a GPS 116. A display 118 is electrically connected to the onboard computer 100. A wireless transceiver 120 may also be electrically connected to the onboard computer 100 to send and receive data, such as to other equipment or to a remote site for further data collection and/or analysis. A mass data storage device 121 which may include removable storage is also electrically connected to the onboard computer 100.

A remote computer 122 with a productivity and financial analysis program(s) 123 is also shown. Although the computer 100 may include a productivity and financial analysis program(s), the present invention contemplates that further analysis may be performed by the remote computer. The remote computer 122 may be in operative communication with a database 124 for storing collected data and/or the analysis of collected data. Data may also be transferred to the remote computer manually through the use of an external data storage device.

The present invention provides for the recording, analysis, evaluation, and modeling of many or all of the factors affecting operational profitability of equipment and employee production and/or output as well as evaluating the actual productivity of a single or collective group of machines, the operators, or the natural resource itself. Furthermore, the present invention may be used to not only monitor, but also to enhance the potential and actual output and/or efficiency of said equipment, operators, and/or the natural resource, thus improving the operational cost parameters of a given production system performing management activities on a natural resource.

The present invention allows a direct or indirect interface between the internal operating systems associated with the functions performed by a specified piece of equipment in addition to monitoring production inputs while recording corresponding external factors which may include but not be limited to geological, hydrological, or atmospheric conditions and perform real-time cost analyses of the aforementioned production parameters against the known production and input costs, both fixed and variable.

The present invention may incorporate the ability to input and display all available geospatial and environmental information associated and contained within a specified area. This information may include, without limitation, geographic, hydrologic, atmospheric data and/or land cover. This information may be interacted with by both the machine and its operator in order to enhance and document productivity and profitability as it relates to the dynamic factors influencing production and profits and analyzed against all known production and input costs to develop profit/loss or break-even models and/or estimates.

The present invention allows for the sending of all recorded events and activities in either a manual data transfer or “real-time wireless” fashion to a remote server or computer for viewing and analysis. The analysis of profitability and/or productivity may occur on the remote computer system or as an internal function of the machine based system.

The present invention contemplates numerous features. Examples of such features may include:
On board operator & equipment interface with all available geospatial information associated with a specified work area.
The input and monitoring of any or all production and input costs, both fixed and variable, along with known or predetermined environmental factors which would influence the operational costs such as maintenance and depreciation and analyze said variables against tachometer time as well as production performance data to develop profit/loss or break-even models and/or estimates. The aforementioned analysis results being available in real-time on the machine, or remotely.
“Real-time” documentation and mapping of actual and specific equipment activities and relationship to all dynamic production factors and analyzing them against production and input costs, both fixed and variable.
   “Real-time” data log, which may be used for determining the “actual” operating and input costs and profitability of equipment with regards to the performance of the exact task for which said equipment was designed vs. actual total time of operation over any pre or post determined period of time. Additionally the system would record all external and internal factors associated with the machine, the job site and/or the operator as it relates to the profitability at any given time or event.
On screen or remote display and/or reporting of estimated or actual production and input costs and profitability for utilization by equipment/natural resource owners/operators in determining current profit/loss or break-even levels.
Real-time” owner/operator awareness of profitability goals vs. actual profit/loss or break-even parameters and the ability to note factors affecting actual profitability as they occur through on screen notes that correlate to a geographic location and time for not only machinery but also the natural resource being managed which includes but is not limited to agricultural crop production and forest products.
“Real-time” wireless and manual transfer of all available data between all operational aspects of natural resource management which may include, but not be limited to, equipment operations, supervisory personnel, logistics activities, and central land management databases such that each transfer updates the impact of each operation on profitability, whether it relates to machinery, natural resource production and/or supervisory activities.
Wireless electronic reconciliation of paperwork associated with operational and input costs and processes through the uses of all associated natural resource information
The system will allow for the input/incorporation of production/operational costs and/or revenue from operations associated with a particular natural resource performed by machinery not equipped with the present invention.

The present invention provides a fully integrated system, which may be interfaced with any land management and/or natural resource database being utilized to record, document, and store any event or activity that has or will transpire with regards to any specified parcel or collective parcels of land, along with their associated natural resources. This information may then be used to create a new level of productivity and profitability modeling as it pertains to the impact of the dynamic factors associated with the production, productivity, and profitability of a specified unit or group of units of equipment (such as dozers, excavators, tractors, sprayers, harvesting equipment, etc.) operators, and/or natural resource which may include, but not be limited to, agricultural and forest lands.

The documentation and modeling of the correlation between all production variables and respective activities and the associated cost of operations may be utilized for, but not limited to the following:
“Real-time” profit/loss or break-even analysis of equipment operations and\or natural resource production.
Appropriate equipment selection or designs to increase productivity and profitability as well as appropriate natural resource production management input selection for maximizing/optimizing productivity and profitability.
Developing theoretical models for profitability individually or as collective groups of equipment or parcels of natural resources on any given task or input under varying operational conditions.

The invention may be further used to remotely monitor and manage changing profitability levels and output of equipment, operators, and/or natural resources for the purposes of improving and making management decisions. Stated management decisions may be in reference to production practices on said natural resource, employee performance and compensation, machine selection, performance, and/or replacement, job selection and costing, and environmental impact documentation.

The present invention provides a new approach to the collecting, processing, and modeling of information as it pertains to the events that transpire during the interaction between machines, people, and natural resources. The present invention provides the ability to easily, quickly, and fully input, collect and analyze individual or combinations of factors that continually affect profitability and productivity of people, machines, and natural resources as single units of production or as a collective group.

Furthermore, the present invention provides the ability to enhance the profitability analyses concerning environmental management in ways previously not possible without significant direct human interaction through observation, documentation, and analysis. Additionally, the invention provides the ability to monitor as well as perform the stated tasks and analyses in a “real-time” fashion either on site for the benefit of the machine owner/operator or remotely for management or production purposes.

Examples of benefits provided by the present invention may include, but are not limited to:
Improved equipment design and manufacturing through a better understanding of all variable elements that can and do impact equipment productivity and profitability at any specified period of time while performing any specified task.
Improved efficiency and profitability through the elimination/reduction of subsequent data collection (costs) and analyses used for profitability analysis
Improved productivity and cost optimization for optimizing production and profitability by increasing outputs both from machinery and the natural resource (such as agricultural crop production and forest management) being managed as well as reducing the effort required to determine up-to-date profitability levels

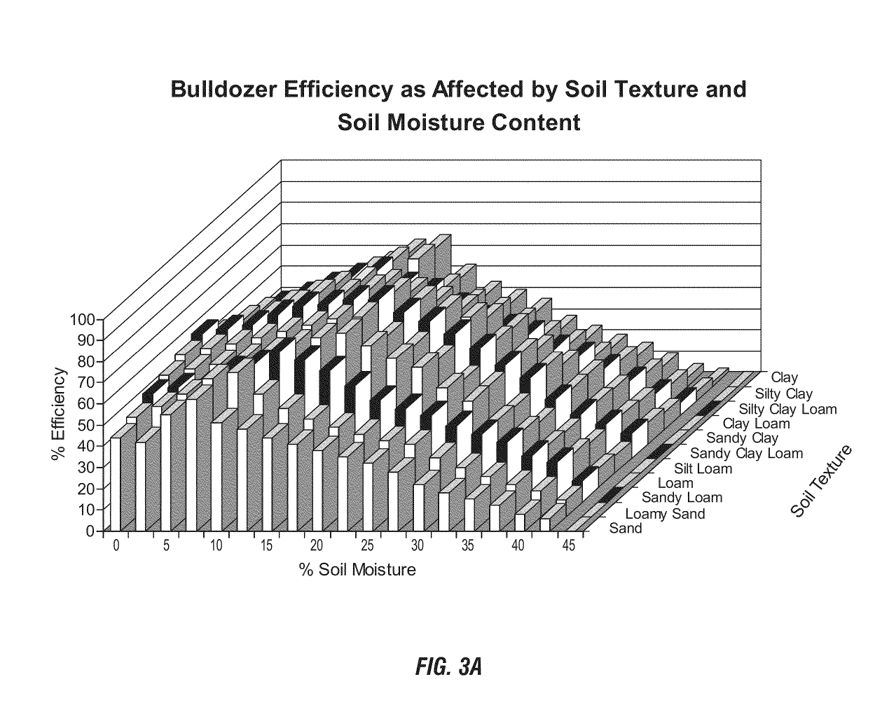

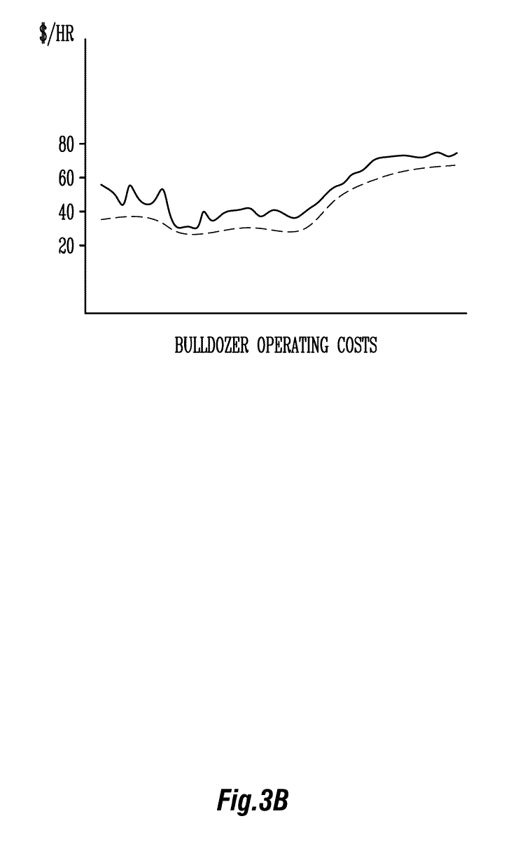

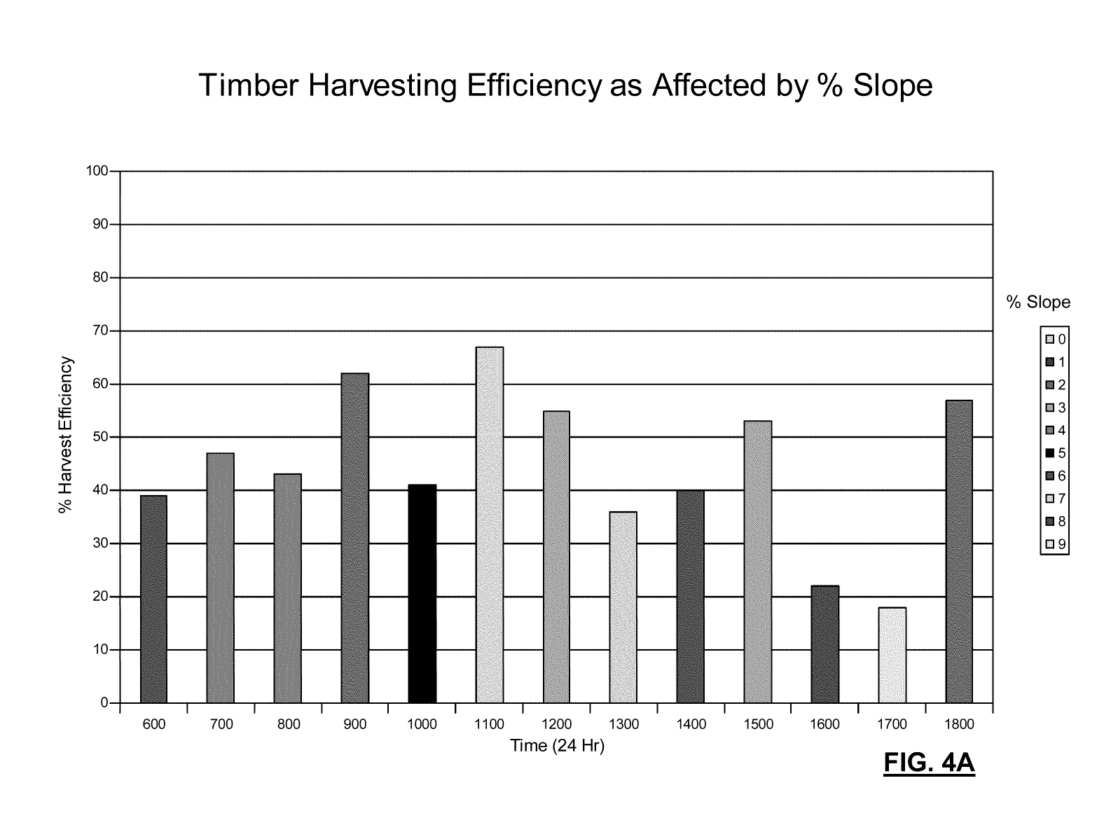

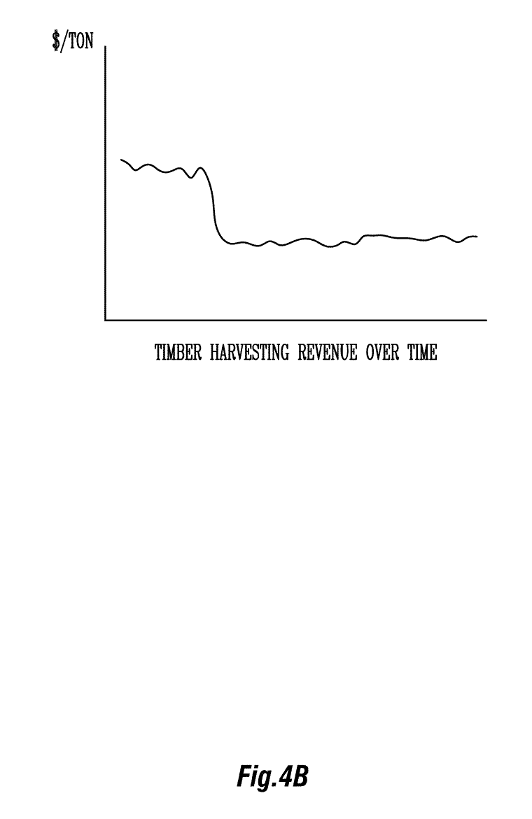

FIGS. 3A, 3B, 4A, and 4B provide examples of screen displays showing productivity reporting of information associated with the present invention. The productivity reporting may be performed using an onboard computer on a machine or may be provided at a remote location.

FIG. 3A is an example of a screen display showing a report on bulldozer efficiency as affected by soil texture and soil moisture. Note that in FIG. 3A, there is a demonstrated relationship between soil moisture and soil texture and the efficiency of a bulldozer. By capturing soil moisture and soil texture information for a work site, the productivity of a bulldozer operator can be better measured, monitored, and modeled.

FIG. 3B is an example of a screen display showing a chart on bulldozer operating costs as measured in dollars per hour. Some of the differences in the operating costs may be explained by changes in the soil and/or terrain associated with a project, the manner in which the operator operates the bulldozer, and other factors. The dotted line in FIG. 3B illustrates an optimal or desired cost level which may take into account changes in the soil and/or terrain associated with a project and other environmental factors such that the primary remaining contribution to operating costs is operator efficiency. Displaying the screen display of FIG. 3B on a display associated with the bulldozer such a display associated with an onboard computer allows the operator to monitor their own productivity and potentially make changes in their operation of the bulldozer to improve productivity. It also provides a meaningful and objective target for the bulldozer operator and reminds them how there use of the bulldozer impacts the operating cost. In addition, this information (or reports generated from this information) may be reviewed by those managing the bulldozer operator to provide one form of objective assessment of the performance of the bulldozer operator.

FIG. 4A is an example of a screen display of timber harvesting efficiency as affected by percent slope. Note that where there is no slope, timber harvesting efficiency is highest. Where there is a 9 percent slope, timber harvesting is least efficient. By capturing this relationship, the productivity and profitability of particular timber harvesting operations may be better measured, monitored, and modeled.

FIG. 4B is an example of a screen display of timber harvesting revenue over time. In the example of FIG. 4B, initially the timber harvesting may take place at a flat area and then the timber harvesting continues on a sloped area. The revenue in dollars per ton decreases for the sloped area. Displaying the screen display of FIG. 4B on a display associated with timber harvesting equipment (such as a display associated with an onboard computer of timber harvesting equipment) allows the operator to monitor the revenue as it related to their operation on the equipment. Having this information available to the operator encourages them to operate in a manner which generates more revenue and to appreciate the effect of their work on revenue. In addition, this information (or reports generated from such information) may be reviewed by those managing operations to evaluate the operator or other aspects of the timber harvesting operation.

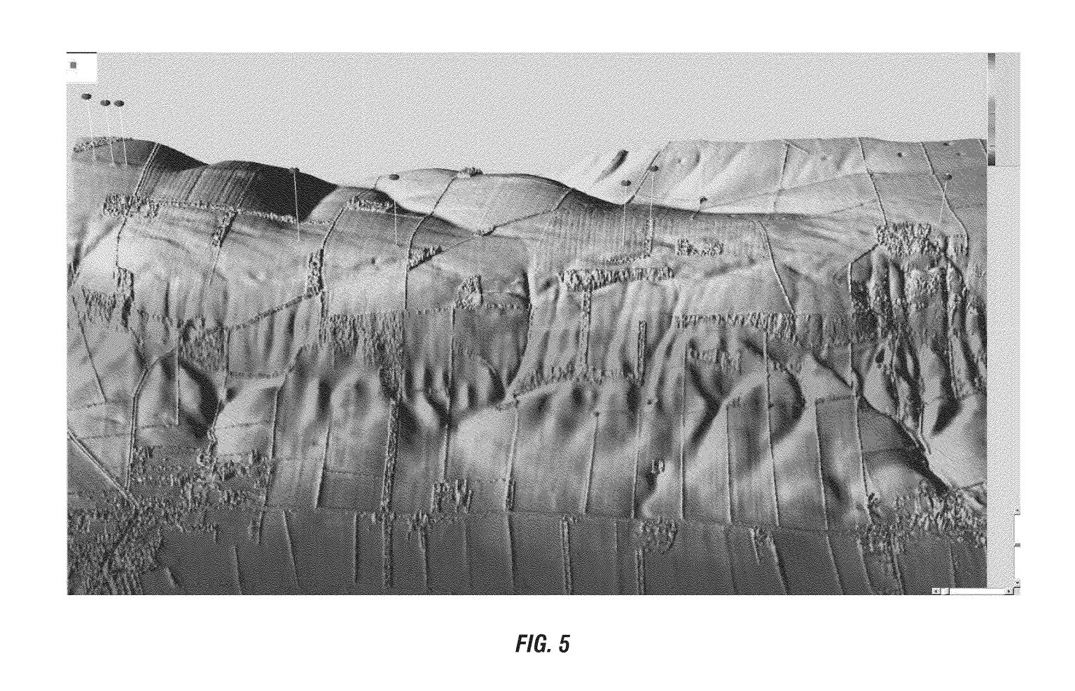

FIG. 5 is a LIDAR image which is indicative of productivity over a specified geographic area. Different colors may be used to indicate productivity. For example, blue may indicate a low production area, yellow may indicate a higher production area, and red may indicate the highest production area. Production may be measured with respect to particular machine operations, or particular operators. This information may be used by managers on-site or off-site at the time of operation or at a later time. This information may also be made available on onboard systems of equipment so that different operators may monitor the productivity of the geographic area in which they are operating, have operated in, or may operate within.

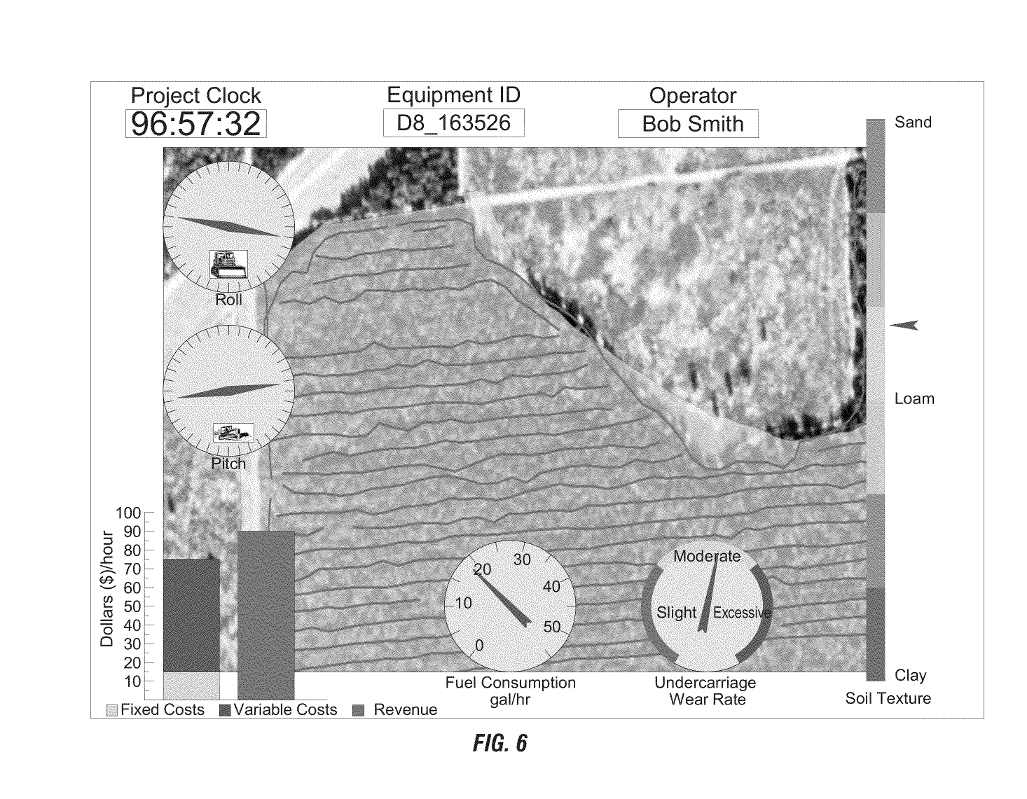

FIG. 6 is an example of a screen display illustrating real-time profitability monitoring for a bulldozer. The screen display shown in FIG. 6 may be provided on a display associated with an onboard computer of a bulldozer or on a computer remotely connected to the bulldozer. The information shown on the screen display may include a map and corresponding GIS information. Note that in FIG. 6 information regarding soil texture (such as sand, loam, or clay) is provided. In addition, a chart indicative of dollars per hour for fixed costs, variable costs, and revenue is provided. A gage is provided illustrating fuel consumption in gallons per hour. In addition, a gage illustrating undercarriage wear rate is provided. Also, a gage is shown which indicates pitch and roll associated with the bulldozer. Also present is a project clock, an equipment identifier, and an operator identifier. Of course additional information pertinent to the operation may also be provided on the screen display. In operation, an operator will have access to information which may be used to assist in increasing productivity and/or profitability. As previously explained, differences in soil texture may affect productivity and profitability. When an operator has this and other information available to them, they will be able to better monitor and improve their own productivity and profitability. Data collected may also be made available in the form of reports or other analysis to those who are evaluating the performance of the operator.

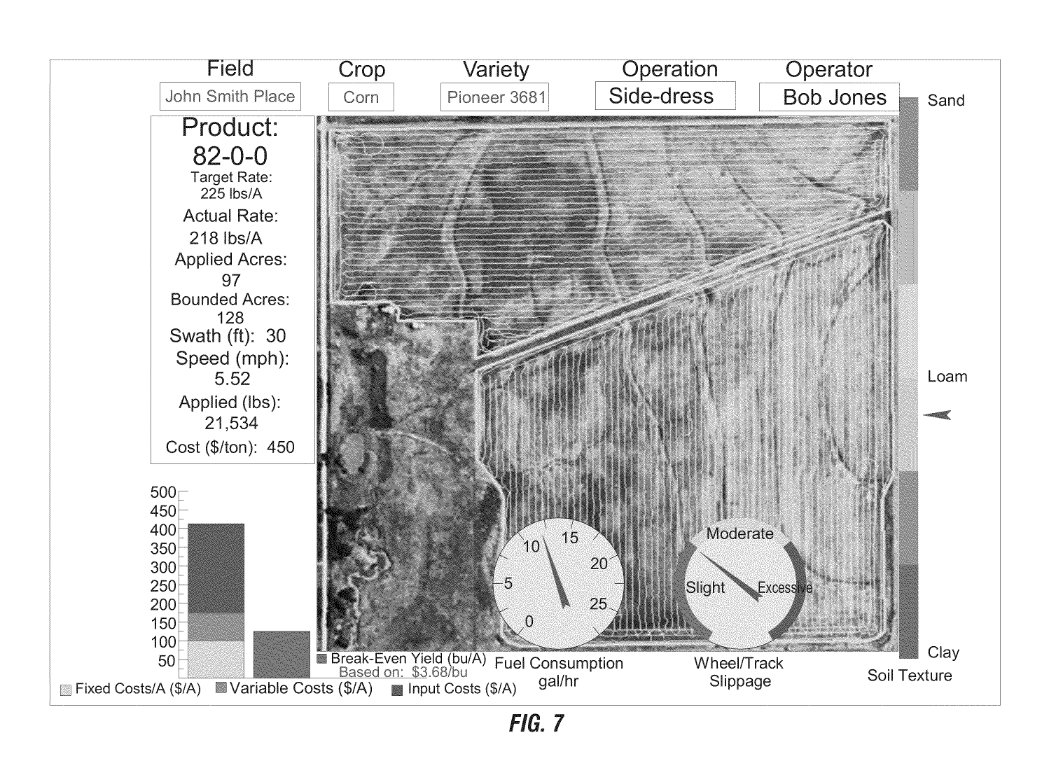

FIG. 7 is an example of a screen display illustrating real-time profitability monitoring for agricultural operations. The information shown on the screen display may include a map and corresponding GIS information. Note that in FIG. 7 information regarding soil texture (such as sand, loam, or clay) is provided. In addition, a chart indicative of dollars per acre for fixed costs, variable costs, and input costs is provided. A gage is provided illustrating fuel consumption in gallons per hour. A gage illustrating wheel/track slippage is also provided. Of course other sensors for monitoring machine operation may also be present and where used and relevant to the productivity or profitability being measured, gages or other displays for these sensors may also be used. A data summary is also provided which such information as product being used, target rates, actual rates, applied acres, bounded acres, swath, speed, applied product, and cost. Also present is data indicative of an equipment identifier, a crop, a variety, an operation, and an operator. Of course additional information may also be provided on the screen display as is pertinent to the operation.

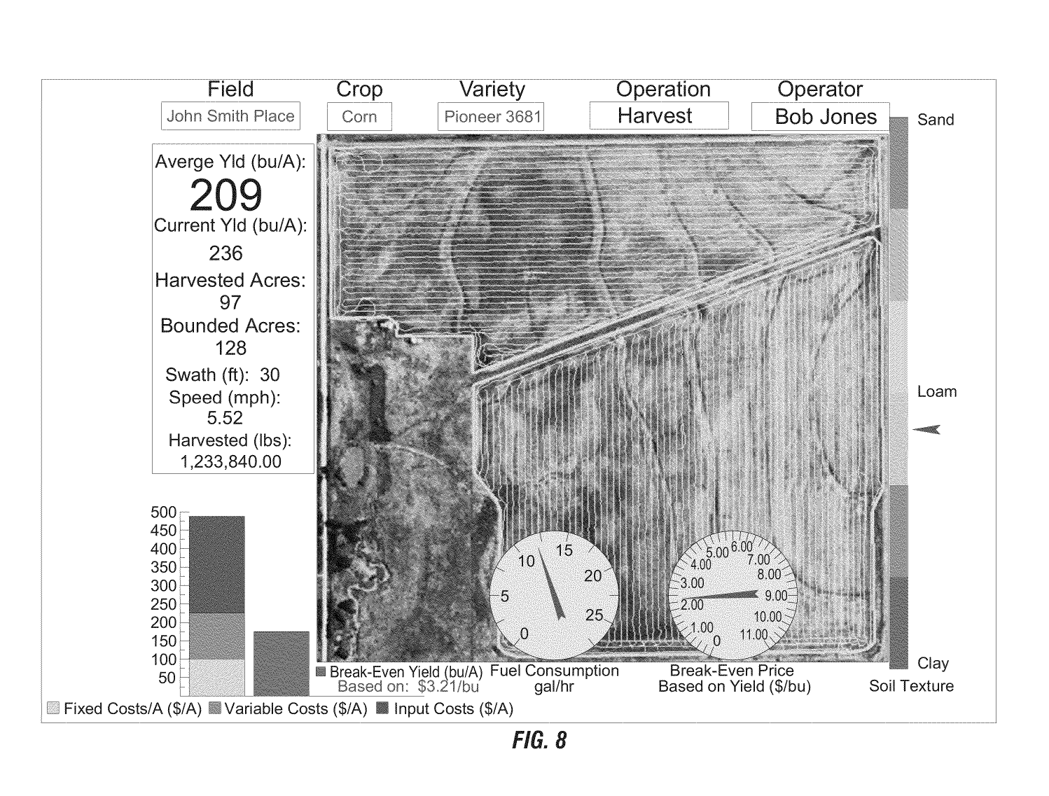

FIG. 8 is an example of a screen display illustrating real-time profitability monitoring for agricultural harvest. The information shown on the screen display may include a map and corresponding GIS information. Note that in FIG. 8 information regarding soil texture (such as sand, loam, or clay) is provided. In addition, a chart indicative of dollars per acre for fixed costs, variable costs, and input costs is provided. A gage is provided illustrating fuel consumption in gallons per hour. A gage illustrating break-even price based on yield. A data summary is also provided which such information as average yield, current yield, harvested acres, bounded acres, swath, speed, and amount harvested. Also present is data indicative of an equipment identifier, a crop, a variety, an operation, and an operator. Of course additional information may also be provided on the screen display as is pertinent to the operations.

Although embodiments shown have focused on natural resource management which is primarily land-based (such as applications associated with forestry, construction), it is to be further understood that the natural resources may include water bodies as well, including, but not limited to streams, rivers, ponds, lakes or oceans.

Therefore, methods and systems for monitoring and analyzing productivity, profitability, or revenue of a machine, its operator(s), and/or a natural resource has been disclosed. Although various examples are given, the present invention is not to be limited to the specific types of machine, types of equipment, or types of analysis, or natural resource production, but rather the present invention contemplates numerous variations, options, and alternatives.

What is claimed is:

1. A method, comprising:
collecting cost data indicative of production systems using machinery on or in conjunction with natural resource management using an onboard computer of the machine;
collecting environmental data using the onboard computer, the environmental data indicative of environmental conditions associated with use of the machine and/or management and production of a natural resource.
collecting machine and/or natural resource data using the onboard computer, the machine data indicative of operation of the machine and production of the natural resource; and
performing an analysis of at least one of cost data or revenue data using the environmental data and the machine data, the analysis performed using the onboard computer or a computer remotely connected.

2. The method of claim 1 further comprising displaying a screen display on a display electrically connected to the onboard computer, wherein the screen display provides results of the analysis.

3. The method of claim 1 wherein the machine data includes occurrences of a machine operation indicative of profitability and productivity of the machine and/or the natural resource

4. The method of claim 1 wherein the environmental data includes geological data.

5. The method of claim 1 wherein the environmental data includes hydrological data.

6. The method of claim 1 wherein the environmental data includes atmospheric data.

7. The method or claim 1 wherein the environmental data includes land cover data.

8. The method of claim 1 wherein the cost data or revenue data is projected cost data or projected revenue data.

9. A system for monitoring productivity associated with a machine, the system comprising:
an onboard system on the machine;
a display electrically connected to the onboard system;
at least one environmental monitoring sensor electrically connected to the onboard system;
at least one machine operation monitoring sensor electrically connected to the onboard sensor; and
wherein the onboard system being programmed to perform financial analysis functions using data acquired from the at least one environmental monitoring sensor and the at least one machine operation monitoring sensor.

10. The system of claim 9 wherein the financial analysis functions include determining cost rates.

11. The system of claim 9 wherein the financial analysis functions include revenue rates.

12. The system of claim 11 wherein the revenue rates being associated with or utilizing cost/revenue rates input/incorporated from additional operations performed by machinery associated with the natural resource being managed.

13. The system of claim 9 further comprising a GIS application executing on the onboard system.

14. The system of claim 9 further comprising a wireless transceiver electrically connected to the onboard system.

15. The system of claim 9 wherein the financial analysis functions include calculating operating costs for use in determining real-time profitability.

16. The system of claim 9 wherein the financial analysis functions include calculating revenue associated with the machine or a natural resource.

17. A method, comprising:
collecting operator data indicative of operator use of a machine using an onboard computer of the machine;
collecting environmental data using the onboard computer, the environmental data indicative of environmental conditions associated with use of the machine;
collecting machine data using the onboard computer, the machine data indicative of operation of the machine;
performing an analysis of the operator data, the environmental data, and the machine data using the data collected by the onboard computer.

18. The method of claim 17 further comprising displaying a screen display on a display electrically connected to the onboard computer, wherein the screen display illustrates results of the analysis.

19. The method of claim 17 wherein the machine data includes occurrences of a machine operation indicative of productivity of the machine.

20. A system for monitoring productivity associated with a machine, the system comprising:
an onboard system on the machine;
a display electrically connected to the onboard system;
at least one operator monitoring sensor electrically connected to the onboard system;
at least one environmental monitoring sensor electrically connected to the onboard system;
at least one machine operation monitoring sensor electrically connected to the onboard system.

21. The system of claim 20 further comprising a GIS application executing on the onboard system.

22. The system of claim 20 further comprising a wireless transceiver electrically connected to the onboard system.

23. The system of claim 20 further comprising an RFID reader electrically connected to the onboard system.

24. The system of claim 20 further comprising a software application on the onboard system programmed for (a) analyzing data from the at least one operator monitoring sensor, the at least one environmental monitoring sensor, and the at least one machine operation monitoring sensor, (b) generating a screen display indicative of productivity and displaying the screen display on the display.
